(19) United States
(12) Patent Application Publication
(10) Pub. No.: US 2014/0195554 A1
(43) Pub. Date: Jul. 10, 2014

(54) SYSTEM AND METHOD FOR CASE ACTIVITY MONITORING AND CASE DATA RECOVERY USING AUDIT LOGS IN E-DISCOVERY

(71) Applicant: INTERNATIONAL BUSINESS MACHINES CORPORATION, Armonk, NY (US)

(72) Inventors: Rajesh M. Desai, San Jose, CA (US); Magesh Jayapandian, San Jose, CA (US); Aidon P. Jennery, El Sobrante, CA (US); Terry L. Kemp, Box Elder, SD (US)

(73) Assignee: INTERNATIONAL BUSINESS MACHINES CORPORATION, Armonk, NY (US)

(21) Appl. No.: 13/736,595

(22) Filed: Jan. 8, 2013

(51) Int. Cl. G06F 17/30

(52) U.S. Cl. CPC G06F 17/30386
USPC 707/758

(57) ABSTRACT

A method, apparatus and article of manufacture for analyzing data recorded in an audit log generated as part of an electronic discovery (e-Discovery) process in litigation is disclosed. In at least one embodiment of the present invention, a computer implemented method of analyzing data recorded in an audit log generated as part of an electronic discovery (e-Discovery) process in litigation is provided. The method comprises retrieving, on one or more computers, an audit log from a storage system accessible from the computer, the audit log comprising data regarding a chronological sequence of actions taken to produce case documents relevant in litigation. The data in the audit log is analyzed and a comprehensive overview of the electronic discovery process is compiled based on the analyzed data for presentation to a user.

### BACKGROUND OF THE INVENTION

The present invention relates generally to systems and methods for audit log analysis, and in particular, to a system and method for analyzing data recorded in an audit log generated as part of an electronic discovery (e-Discovery) process in litigation.

### SUMMARY OF THE INVENTION

The invention provided herein has a number of embodiments useful, for example, in utilizing audit logs and extending the role of audit logs to serve additional functions of interest in the context of e-Discovery. According to one or more embodiments of the present invention, a method, apparatus, and computer program product is provided for analyzing data recorded in an audit log generated as part of an electronic discovery (e-Discovery) process in litigation.

In one aspect of the present invention, a computer implemented method is provided for analyzing data recorded in an audit log generated as part of an electronic discovery (e-Discovery) process in litigation. On one or more computers, an audit log is retrieved from a storage system accessible from the computer. The audit log comprises data regarding a chronological sequence of actions taken to produce case documents relevant in litigation. The data in the audit log is analyzed and a comprehensive overview of the electronic discovery process is compiled based on the analyzed data for presentation to a user. The actions recorded in the audit log include any user-generated content (e.g. flags, comments, etc.) associated with the production of the case document, which may be recorded as additional metadata for the document.

In one embodiment of the invention, the computer implemented method further monitors, on one or more computers, activity in the electronic discovery process based on the analyzed data. In another embodiment of the invention, the computer implemented method further recovers, on one or more computers, a previously produced case document that is corrupted based on the analyzed data. Corruption of a case document includes lost or corrupted metadata associated with the case document (e.g. lost or corrupted flags, comments, etc.). In a further embodiment of the invention, the audit log is cached in the storage system to speed up the analysis of the data in the audit log. In another embodiment of the invention, the computer implemented method further controls, on one or more computers, the expiration of case documents produced during the electronic discovery process based on the analyzed data.

### BRIEF DESCRIPTION OF THE DRAWINGS

Referring now to the drawings in which like reference numbers represent corresponding parts throughout:

FIG. 1 is a diagram illustrating an exemplary network data processing system that can be used to implement elements of the present invention;

FIG. 2 is a diagram illustrating an exemplary data processing system that can be used to implement elements of the present invention;

FIG. 3 is a diagram illustrating an exemplary data processing system that can be used to implement elements of the present invention;

FIG. 4 is a diagram illustrating exemplary process steps that can be used to practice at least one embodiment of the present invention;

FIG. 5A is a diagram illustrating an exemplary storage architecture, according to at least one embodiment of the present invention;

FIG. 5B is a diagram illustrating a second exemplary storage architecture, according to at least one embodiment of the present invention;

FIG. 5C is a diagram illustrating a third exemplary storage architecture, according to at least one embodiment of the present invention; and

FIG. 6 is a diagram illustrating a general relationship between the performance and recoverability of cases depending on the flush interval.

### DETAILED DESCRIPTION OF THE INVENTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

### Overview

An audit log is a chronological sequence of audit records, each of which provides evidence directly pertaining to and resulting from the execution of a business process or system function (see, e.g. http://en.wikipedia.org/wiki/Audit_trail). Audit logs play an important role in the electronic discovery (e-Discovery) process. During the e-Discovery process, documents relevant to litigation often need to be located and extracted from very large collections of company documents. When producing such documents as evidence during litigation, the process that led to the selection of those documents is also very important. The sequence of actions that reviewers take to produce the documents is generally captured in audit logs, which corroborate the relevance of the produced documents and are thus usually produced alongside the documents as evidence. Any action pertinent to the litigation process must be recorded in the audit log. This may include audit records and metadata corresponding to actions taken to create collections of business documents, such as emails, business reports, and memos, as well as actions taken to categorize, index, search, analyze, annotate, and print these documents. For this reason, audit logs are indispensable to the e-Discovery process and are generally retained at all costs as an essential component of an e-Discovery product.

Embodiments of the present invention provide for non-traditional applications of audit logs in the context of e-Discovery systems and processes. Systems and methods are provided for analyzing and managing audit logs and records, which relate to litigation as well as post-litigation processes.

### Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

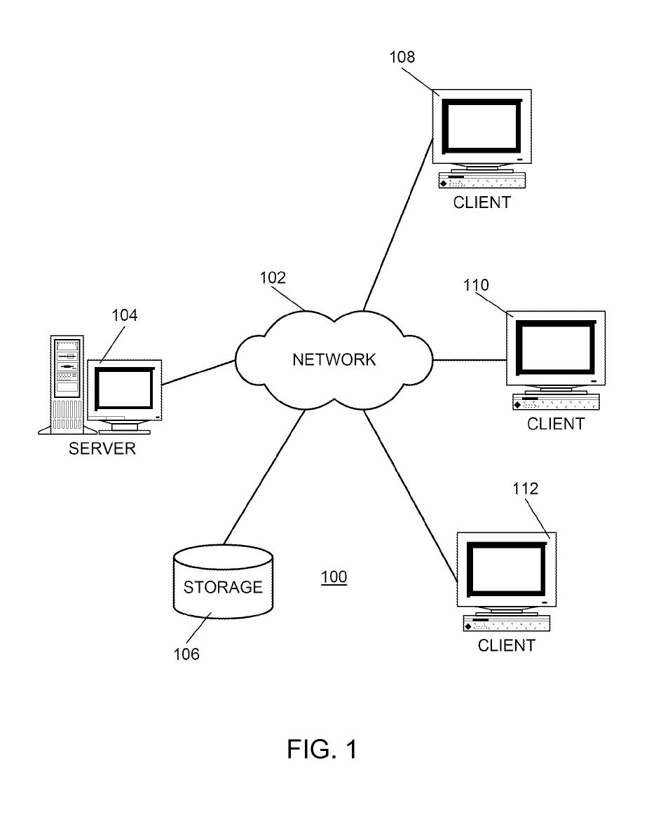

With reference now to FIG. 1, a pictorial representation of a network data processing system 100 is presented in which the present invention may be implemented. Network data processing system 100 contains a network 102, which is the medium used to provide communications links between various devices and computers connected together within network data processing system 100. Network 102 may include connections, such as wire, wireless communication links, or fiber optic cables etc.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and programs to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another.

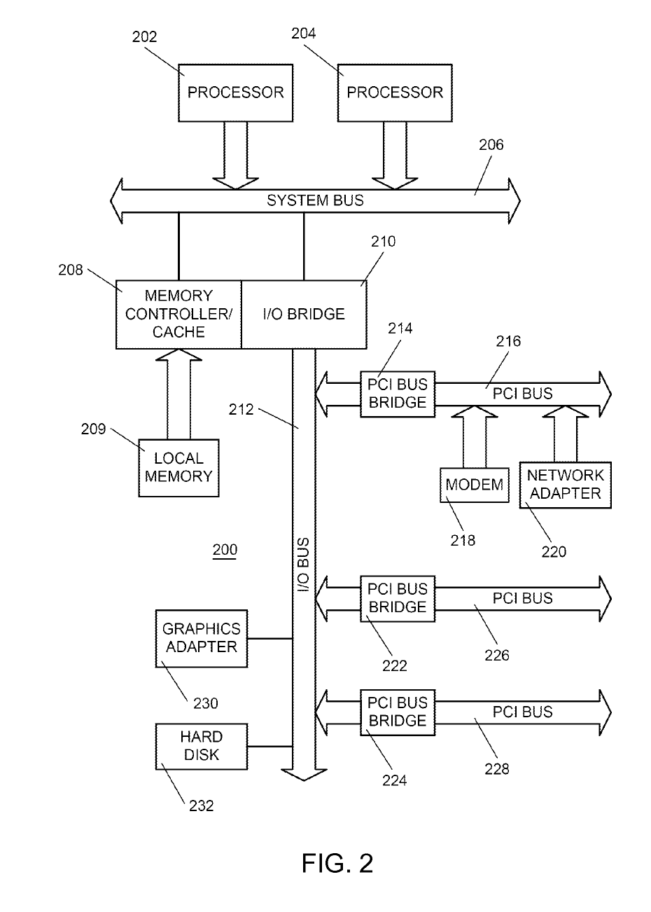

Referring to FIG. 2, a block diagram of a data processing system that may be implemented as a server, such as server 104 in FIG. 1, is depicted in accordance with an embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

Server 104 may provide a suitable website or other internet-based graphical user interface accessible by users to enable user interaction for aspects of an embodiment of the present invention. In one embodiment, Netscape web server, IBM Websphere Internet tools suite, an IBM DB2 for Linux, Unix and Windows (also referred to as “IBM DB2 for LUW”) platform and a Sybase database platform are used in conjunction with a Sun Solaris operating system platform. Additionally, components such as JBDC drivers, IBM connection pooling and IBM MQ series connection methods may be used to provide data access to several sources. The term webpage as it is used herein is not meant to limit the type of documents and programs that might be used to interact with the user. For example, a typical website might include, in addition to standard HTML documents, various forms, Java applets, JavaScript, active server pages (ASP), Java Server Pages (JSP), common gateway interface scripts (CGI), extensible markup language (XML), dynamic HTML, cascading style sheets (CSS), helper programs, plug-ins, and the like.

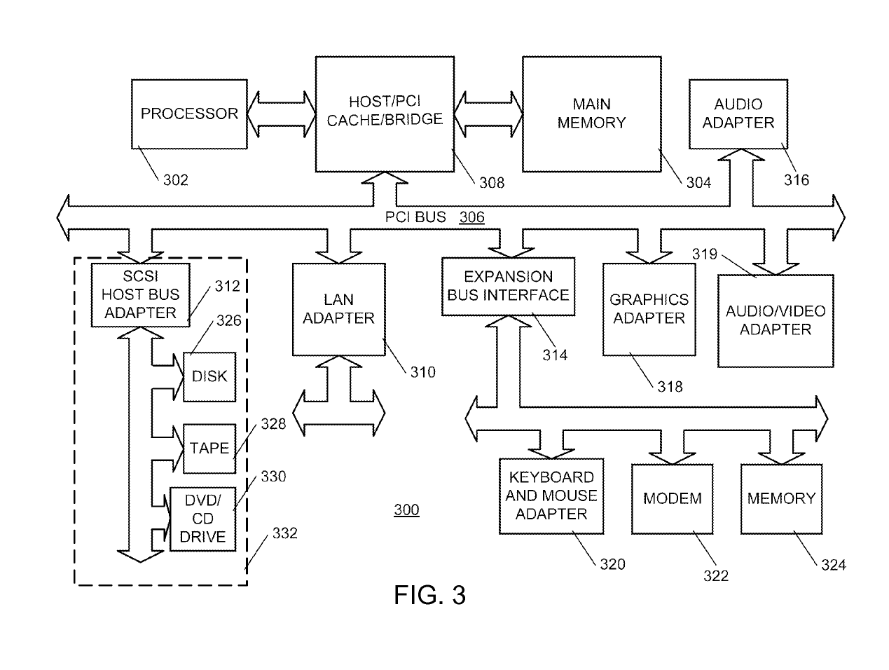

With reference now to FIG. 3, a block diagram illustrating a data processing system is depicted in which aspects of an embodiment of the invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots.

Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP®, which is available from Microsoft Corporation. An object oriented programming system such as Java may run in conjunction with the operating system and provide calls to the operating system from Java programs or programs executing on data processing system 300. “Java” is a trademark of Sun Microsystems, Inc. Instructions for the operating system, the object-oriented operating system, and programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer as well as a PDA. Further, data processing system 300 may also be a kiosk or a Web appliance. Further, the present invention may reside on any data storage medium (i.e., floppy disk, compact disk, hard disk, tape, ROM, RAM, etc.) used by a computer system. (The terms “computer,” “system,” “computer system,” and “data processing system” and are used interchangeably herein.)

Those skilled in the art will recognize many modifications may be made to this configuration without departing from the scope of the present invention. Specifically, those skilled in the art will recognize that any combination of the above components, or any number of different components, including computer programs, peripherals, and other devices, may be used to implement the present invention, so long as similar functions are performed thereby.

For example, any type of computer, such as a mainframe, minicomputer, or personal computer, could be used with and for embodiments of the present invention. In addition, many types of applications other than caching applications could benefit from the present invention. Specifically, any application that performs remote access may benefit from the present invention.

Herein, the term “by” should be understood to be inclusive. That is, when reference is made to performing A by performing X and Y, it should be understood this may include performing A by performing X, Y and Z.

### Analyzing Data Recorded in an Audit Log

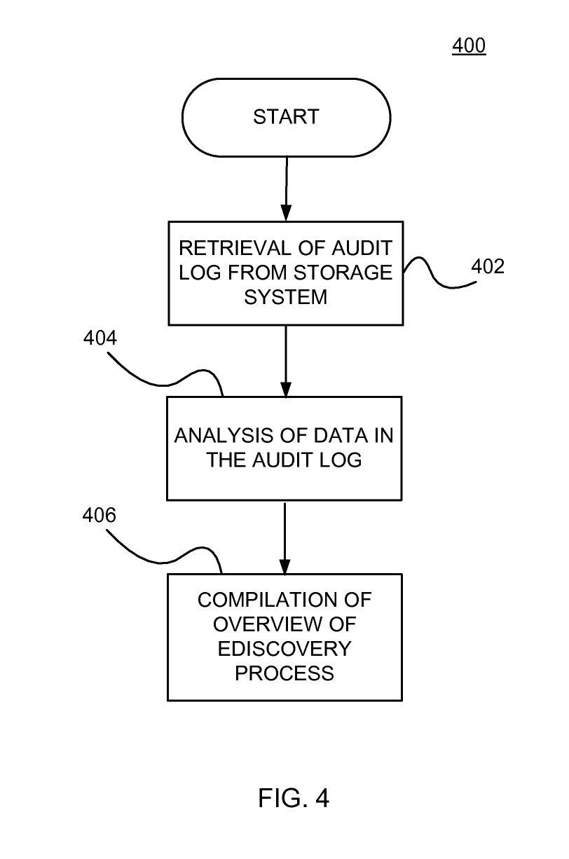

FIG. 4 is a flow chart illustrating exemplary process steps that can be used to practice one or more embodiments of the present invention. A computer implemented method 400 is provided for analyzing data recorded in an audit log generated as part of an electronic discovery (e-Discovery) process in litigation.

In block 402, an audit log is retrieved from a storage system accessible from one or more computers. The audit log comprises data regarding a chronological sequence of actions taken to produce case documents relevant in litigation.

In block 404, the data in the audit log is analyzed on one or more computers.

In block 406, a comprehensive overview of the electronic discovery process is compiled, on one or more computers, based on the analyzed data for presentation to a user.

According to a first embodiment of the present invention, the analyzed data in the audit log is used to monitor case activity during the litigation and e-Discovery process. According to a second embodiment, the analyzed data in the audit log is used to backup and recover lost or corrupted cases or documents involved in the litigation process, which include the metadata for the cases or documents as well as the audit actions leading to the generation of the metadata. According to a third embodiment, the analyzed data in the audit log is used to control case document expiration. According to a fourth embodiment, the audit log is cached to speed up audit analysis. In exemplary implementations, the systems and methods provided operate on top of an existing records management system, such as a FileNet P8™ or CM™ system provided by IBM®.

### Monitoring of Case Activity

According to one aspect of the present invention, the computer implemented method of analyzing data recorded in an audit log generated as part of an e-Discovery process provides for the monitoring of case activity. Apart from producing a monolithic audit report at the end of the e-Discovery process, audit logs can also be used during the process to monitor, track, analyze, and optimize the process itself. In various embodiments, the monitoring of case activity includes reviewing the actions of a particular reviewer, for example, checking up on the actions of a new person assigned with an e-Discovery task. In other embodiments, the monitoring of case activity includes improving the efficiency of the case review/e-Discovery process by locating areas of inefficiency that can be redesigned. Further embodiments include tracking case review/e-Discovery activity and progress towards various goals. In one exemplary implementation, for e-Discovery tasks assigned to multiple reviewers, a supervisor can browse or search the audit log to oversee individual reviewer activity, track progress, detect potential problems, and locate process inefficiencies that can be optimized.

This method and system also provides for early detection of any abnormal activity (both innocent and malicious) in the e-Discovery process, thus avoiding any potentially serious and expensive consequences. Activity that is innocent or unintentional but harmful includes, for example, premature exports of documents and flagging too many documents. Activity that is malicious includes, for example, abuse of access privileges that compromise the security of the documents. Early detection of such abnormal activities is important in preventing any undesirable consequences.

### Recovery of Lost or Corrupted Cases

According to a second aspect of the present invention, the computer implemented method of analyzing data recorded in an audit log generated as part of an e-Discovery process provides for the recovery of lost or corrupted cases. Since the process of gathering evidence can be long and tedious, any loss or corruption of data can set the effort back significantly. A case or document can be lost or corrupted, for example, if the case is deleted or a fatal software or hardware failure occurs.

Full backups of case or document data structures can be potentially large and expensive. In traditional backup recovery mechanisms, full backups of data need to be performed frequently, which incur a recurring cost both in terms of resources and performance (e.g. disk space and CPU cycles). Furthermore, recovery from backups to a globally consistent state with minimal data loss is often a tricky endeavor.

Embodiments of the present invention provide a simple and cost-effective method and system for recovering lost or corrupted documents. The actions by reviewers that are applied to a case manipulate one or more data structures. The current state of the system is a cumulative result of all the actions that were taken by users of the system up to that point. Furthermore, any action that materially changes the contents of a case is recorded as an entry in the audit log. If the audit log is determined to be intact by the system, a lost or corrupted case can be recovered, regenerated or rebuilt from any starting point in the case's history to any consistent state prior to failure by replaying or repeating the actions in the audit log in chronological order. Since the audit log is transactional (i.e. actions or sets of actions are audited only after they are completed, thus leaving the case in a consistent state), recovery to any point in the audit trail will return the case to a globally consistent state from which the e-Discovery process can resume. Different needs for case recovery are satisfied by various embodiments of the invention, which includes, for example, reverting a case to its initial state (e.g. just after creation), reverting a case to its last consistent state (e.g. just before the system crashed or the case was deleted), and reverting a case to any desired state in between (e.g. just before a major action was taken accidentally). As an additional advantage, the original contents of the audit log are retained even after recovery.

Since the audit log is provided for an e-Discovery process, there is little or no overhead for the recovery mechanism provided herein. Additionally, the audit log contains a record of user actions, which can be monitored or analyzed easily by a user, rather than database operations that are hardly human-readable. This allows unhindered user control and input when initiating audit log-based database recovery. Furthermore, with the recovery mechanism provided herein, the system can be rebuilt entirely by replaying the actions recorded in the audit log rather than rely on some backup data, albeit inconsistent data, being available so that the recovery process could roll back to its last backed-up consistent state prior to the crash. This is especially useful if earlier parts of the audit log contain actions that are known to be obsolete and the user decides to skip them during recovery. Moreover, only the audit log needs to be determined to be intact and uncorrupted for the recovery mechanism to bring the system back to a consistent state, which is more cost-effective than regular backups.

### Control Over Case Document Expiration

According to a third aspect of the present invention, the computer implemented method of analyzing data recorded in an audit log generated as part of an e-Discovery process provides for control over the expiration of case documents. Documents in a case are released when they are no longer relevant to the litigation being carried out. Each document is assigned an expiration date. Typically when a case is deleted, so are all the documents in it. However, in some situations, documents in a deleted case may still need to be retained, for example, due to further litigation that may require them or until a statute of limitations expires.

Embodiments of the invention provide a method and system for preserving and accessing such documents after the case has been deleted. Unlike other case artifacts, the audit log is retained even after a case is deleted and within it are references to each document on which some audit-worthy action was taken. These references provide the location and a handle or pointer for each document, thus retaining them for later access. Additionally, once the documents are accessed via the audit log, their expiration dates may be updated with new expiration dates that are propagated down to an underlying records management system (e.g. IBM® Content Manager, IBM® FileNet Records Manager), which is responsible for the classifying, storing, and disposing of these cases and documents. This may be accomplished through the use of some simple extensions.

### Caching of Audit Logs to Speed Up Audit Analysis

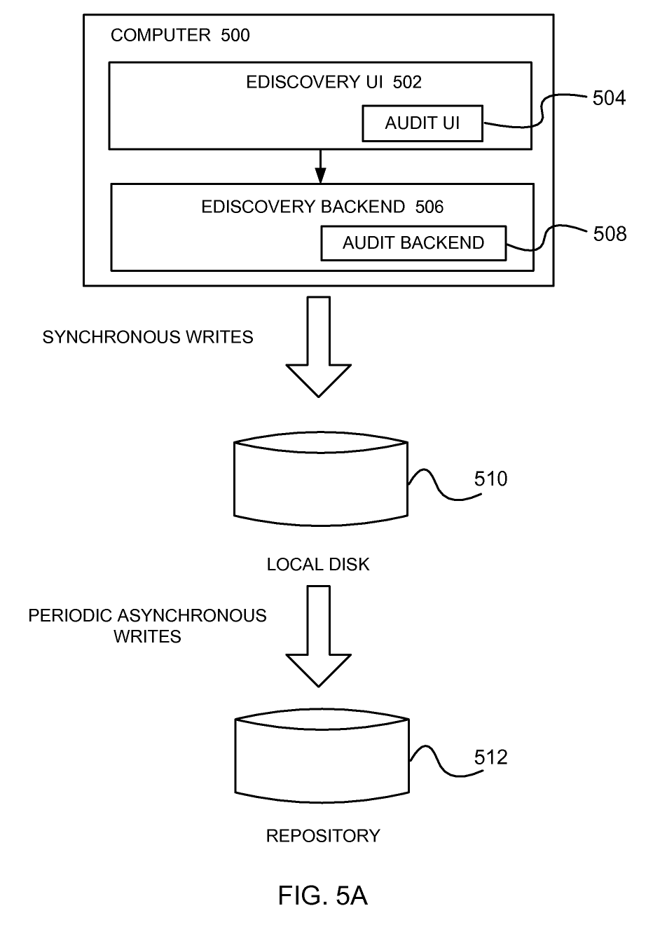

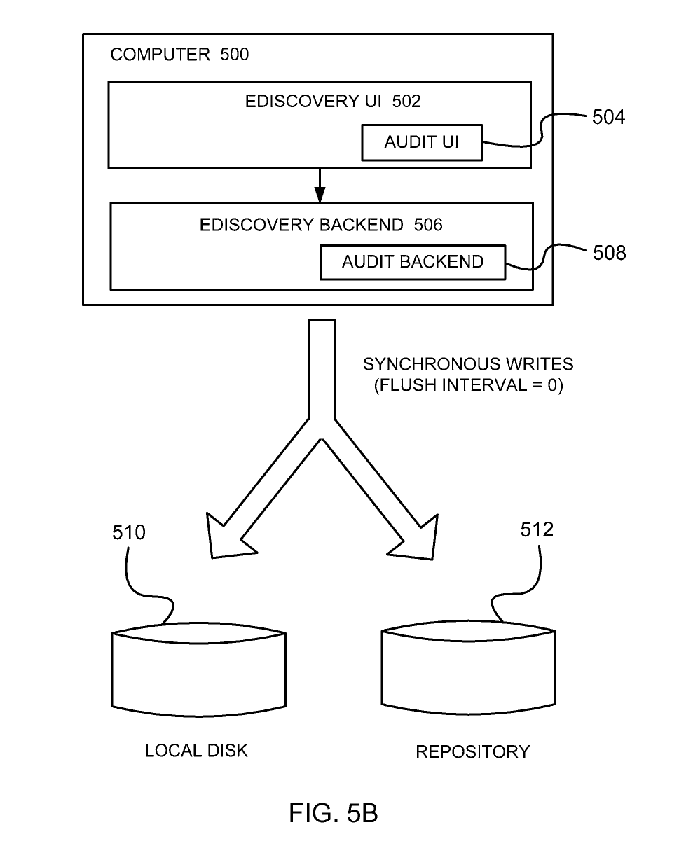

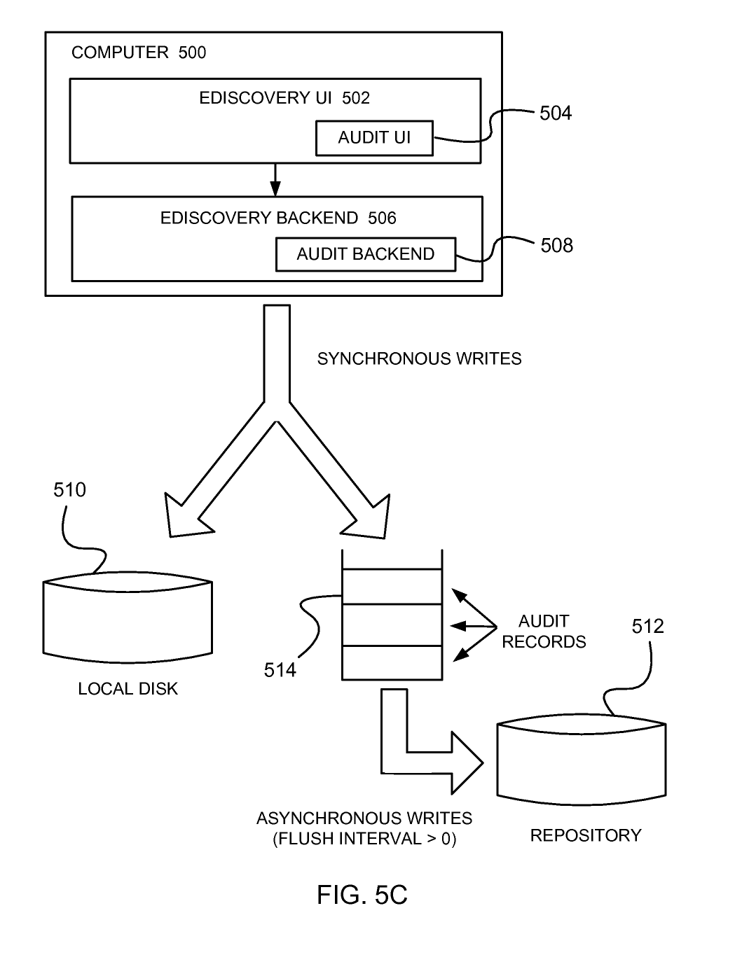

According to a fourth aspect of the present invention, the computer implemented method of analyzing data recorded in an audit log generated as part of an e-Discovery process provides for the caching of audit logs to speed up audit analysis, as illustrated in FIGS. 5A-C. On a computer 500, a user typically only sees and interacts with a front-end e-Discovery user interface (UI) 502. The e-Discovery UI 502 includes an audit log user interface 504 module. The computer 500 also has an e-Discovery back-end 506, which includes an audit backend 508 for the audit log, to support the front-end UI. The e-Discovery back-end 506 may be located on the same computer or remotely-located on a different computer or server. Part of the audit back-end 508 process is the caching and storage of audit logs and records. The storage device onto which the audit log is written is critical to its usability. It is important that the audit log for a case be salvageable if the case is lost or corrupted due to hardware failure. So regardless of where the case is stored, the storage system for its audit log must be one that is stable and frequently backed up.

In at least one embodiment, the audit log is stored in a content repository 512 (i.e. repository storage) or other backup system to ensure high availability and permanence. The repository 512 may be a remotely-located server. In an exemplary implementation, a queue-like structure 514 allows batch writes to the repository. The queue 514 is flushed periodically (depending on the flush interval) and reduces the load on the repository.

In other embodiments, fast access is needed for deep real-time analysis and monitoring of case activity via audit logs. In at least one embodiment, the audit log is stored locally on a disk-based index 510 (i.e. disk storage) to allow fast searching and analysis in answering queries of interest. While such a data structure facilitates interactive querying, it does not provide the same availability and recoverability guarantees that a content repository does.

In preferred embodiments, the audit log is stored in both a repository 512 and local disk 510 (i.e. dual storage model) to provide balancing between performance and recoverability depending on the needs of the user. In the dual storage model, audit records are eventually persisted on a repository 512 but in the meantime are also cached in an index on a local disk 510. Storing an audit log in a repository 512 ensures high availability and permanence of audit logs and records and storing it on a local disk 510 allows faster searching and analysis of audit logs and records for user queries.

In at least one embodiment, as shown in FIG. 5A, the audit log is synchronously written to a local disk 510 and then periodically stored on a repository 512 asynchronously to add recoverability qualities. In other embodiments, as shown in FIG. 5B, the audit log is synchronously written to both a local disk 510 and repository 512. In further embodiments, as shown in FIG. 5C, the audit log is synchronously written to both a local disk 510 and a queue 514 that is flushed periodically to provide batch writes to the repository 512.

The two versions of the audit log (separately stored on the local disk and on the repository) must be synchronized periodically. During synchronization, the repository is queried to obtain its last committed or synchronized state. All the audit records from the last synchronized state to the latest consistent state between the repository and the disk storage are then written to the repository. The synchronization is incremental and non-blocking. Furthermore, actions continue to be audited in real-time while synchronization is taking place.

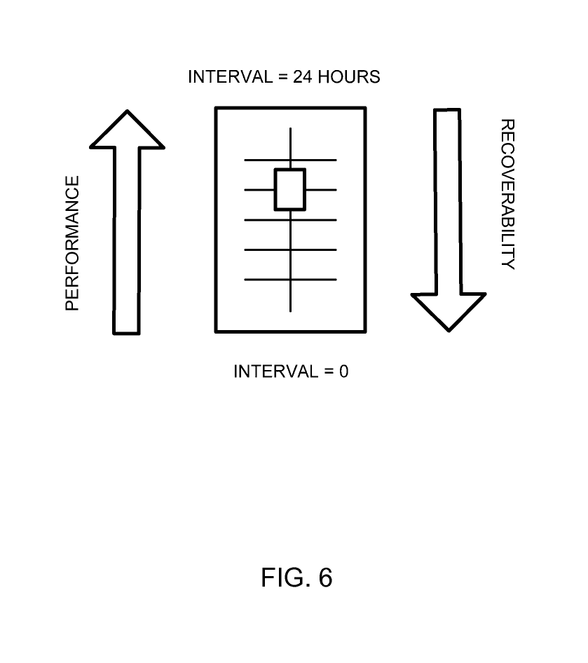

The frequency of synchronization is governed by a “flush interval” which determines the balance between performance and recoverability. FIG. 6 depicts the inverse relationship between performance and recoverability depending on the flush interval, shown for example as a value between 0 and 24 hours. It is to be noted that the range of 0 to 24 hours shown in FIG. 6 is for illustration purposes only and that any length of time may be used for the flush interval. A low flush interval (e.g. close to zero) means less data loss in the event of a failure but it also means that the I/O cost to persist the data is higher, which degrades overall performance. As illustrated in FIG. 5B, if the flush interval equals zero, writing to the local disk 510 and repository 512 is synchronous and reliability is at its maximum. However, frequent repository access has high overhead. On the other hand, as illustrated in FIG. 5C, a high flush interval (e.g. once a day) implies infrequent synchronization, which allows faster search and analysis of the audit log. There is also less overhead for such repository access. However, if a failure occurs, the amount of work lost (work which would need to be repeated) is also greater (e.g. a day's worth of work). The flush interval can be tuned globally or on a finer per-case basis by users depending on their reliability requirements.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer implemented method of analyzing data recorded in an audit log generated as part of an electronic discovery (e-Discovery) process in litigation, comprising:
retrieving, on one or more computers, an audit log from a storage system accessible from the one or more computers, the audit log comprising data regarding a chronological sequence of actions taken to produce case documents relevant in litigation;
analyzing, on the one or more computers, the data in the audit log; and
compiling, on the one or more computers, a comprehensive overview of the electronic discovery process based on the analyzed data for presentation to a user.

2. The computer implemented method of claim 1, further comprising monitoring, on the one or more computers, activity in the electronic discovery process based on the analyzed data.

3. The computer implemented method of claim 1, further comprising recovering, on the one or more computers, a previously produced case document that is corrupted based on the analyzed data.

4. The computer implemented method of claim 3, wherein recovering the previously produced case document includes repeating the chronological sequence of actions taken to produce the case document.

5. The computer implemented method of claim 1, wherein the audit log is cached in the storage system to speed up the step of analyzing the data in the audit log.

6. The computer implemented method of claim 5, wherein the storage system comprises a disk storage and a repository storage, and the audit log is cached in the disk storage and stored in the repository storage.

7. The computer implemented method of claim 1, further comprising controlling, on the one or more computers, expiration of case documents produced during the electronic discovery process based on the analyzed data.

8. A computer implemented apparatus for analyzing data recorded in an audit log generated as part of an electronic discovery (e-Discovery) process in litigation, comprising:
one or more computers; and
one or more processes performed by the one or more computers, the processes configured to:
retrieve an audit log from a storage system accessible from the one or more computers, the audit log comprising data regarding a chronological sequence of actions taken to produce case documents relevant in litigation;
analyze the data in the audit log; and
compile a comprehensive overview of the electronic discovery process based on the analyzed data for presentation to a user.

9. The apparatus of claim 8, wherein the processes are further configured to monitor activity in the electronic discovery process based on the analyzed data.

10. The apparatus of claim 8, wherein the processes are further configured to recover a previously produced case document that is corrupted based on the analyzed data.

11. The apparatus of claim 10, wherein the processes are further configured to repeat the chronological sequence of actions taken to produce the case document to recover the previously produced case document that is corrupted based on the analyzed data.

12. The apparatus of claim 8, wherein the audit log is cached in the storage system to speed up the step of analyzing the data in the audit log.

13. The apparatus of claim 12, wherein the storage system comprises a disk storage and a repository storage, and the audit log is cached in the disk storage and stored in the repository storage.

14. The apparatus of claim 8, wherein the processes are further configured to control expiration of case documents produced during the electronic discovery process based on the analyzed data.

15. A computer program product for analyzing data recorded in an audit log generated as part of an electronic discovery (e-Discovery) process in litigation, said computer program product comprising:
a computer readable storage medium having stored/encoded thereon:
first program instructions executable by one or more computers to cause the one or more computers to retrieve an audit log from a storage system, the audit log comprising data regarding a chronological sequence of actions taken to produce case documents relevant in litigation;
second program instructions executable by the one or more computers to cause the one or more computers to analyze the data in the audit log; and
third program instructions executable by the one or more computers to cause the one or more computers to compile a comprehensive overview of the electronic discovery process based on the analyzed data for presentation to a user.

16. The computer program product of claim 15, further comprising fourth program instructions executable by the one or more computers to cause the one or more computers to monitor activity in the electronic discovery process based on the analyzed data.

17. The computer program product of claim 15, further comprising fourth program instructions executable by the one or more computers to cause the one or more computers to recover a previously produced case document that is corrupted based on the analyzed data.

18. The computer program product of claim 17, wherein the fourth program instructions executable by the one or more computers cause the one or more computers to repeat the chronological sequence of actions taken to produce the case document.

19. The computer program product of claim 15, wherein the audit log is cached in the storage system to speed up the step of analyzing the data in the audit log.

20. The computer program product of claim 15, further comprising fourth program instructions executable by the one or more computers to cause the one or more computers to control expiration of case documents produced during the electronic discovery process based on the analyzed data.
